(19) United States
(12) Patent Application Publication
(10) Pub. No.: US 2002/0156218 A1
(43) Pub. Date: Oct. 24, 2002

(54) Curable resin composition and product treated by the same

(75) Inventors: Yoshitomo Nakata, Suita-shi (JP); Akio Naka, Suita-shi (JP); Miwako Yonezawa, Suita-shi (JP)

Correspondence Address: SUGHRUE MION, PLLC, 2100 Pennsylvania Avenue, NW, Washington, DC, 20037-3213, US

(73) Assignee: NIPPON SHOKUBAI CO., LTD.

(21) Appl. No.: 10/046,733

(22) Filed: Jan. 17, 2002

(30) Foreign Application Priority Data
Jan. 18, 2001 (JP) 2001-010072

(51) Int. Cl. C08F 120/54

(52) U.S. Cl. 526/303.1

(57) ABSTRACT

The present invention is to provide a curable resin composition comprising a new crosslinking system by which both hydrophilicity and water resistance properties are realized, and a product treated by said curable resin composition.

A curable resin composition comprising a polymer having an N-vinyl amide unit and a compound having two or more functional groups reacting with an active hydrogen, and a product treated by said curable resin composition.

### TECHNICAL FIELD

The present invention relates to a curable resin composition and a product treated by the same. Particularly, it relates to a curable resin composition having both hydrophilicity and water resistance by crosslinking a hydrophilic polymer, and a product treated by the same.

### BACKGROUND ART

Hydrophilic treatment of surface of various base materials has been demanded in order to prevent deposit of water drops or clouding caused by them, or to improve the affinity for water-based ink. Hitherto, to meet such needs, it has been attempted to apply a water-soluble polymer or apply a surfactant, but they are dissolved in water and have been far from satisfactory in the duration of the effect.

To provide with water resistance, a water-soluble polymer may be crosslinked by a crosslinking agent or the like, but hydrophilicity and water resistance are mutually contradictory properties, and generally when a water-soluble polymer is crosslinked, although water resistance is expressed, the original hydrophilicity tends to be lost.

Herein, the crosslinking agent refers to a compound having two or more functional groups in one molecule, and the term of crosslinking agent is used hereinafter in this sense of meaning.

Concerning crosslinking of a polymer for expressing hydrophilicity, Japanese Kokai Publication Hei-6-322292 discloses a technology about a polymer composition for hydrophilic treatment comprising a combination of at least two species of polymers selected from the group consisting of a polymer (a) having a carboxylic group, a polymer (b) capable of forming a polymer complex by hydrogen bonding with the polymer (a), and a polymer (c) having a carboxylic group and having polymer complex forming capability by hydrogen bonding by itself alone, in which examples using a water-soluble melamine resin as a water-soluble crosslinking agent are presented.

In these technologies, it is intended to incorporate polyvinyl pyrrolidone in an IPN form in the crosslinked network structure, but it is not intended to crosslink PVP directly.

Japanese Kokai Publication Hei-8-291269 discloses a composition for hydrophilic treatment comprising a copolymer (a) of vinyl pyrrolidone and acrylic acid, and (b) polyethylene glycol diglycidyl ether, a ratio of (a) to (b) being (a)/(b)=20/80 to 70/30 by weight of solid matter, and amines (c) at a specific weight ratio. In this composition for hydrophilic treatment, in the copolymer (a), pyrrolidone ring derived from vinyl pyrrolidone and carboxyl group derived from acrylic acid are hydrogen-bonded to form a polymer complex so that the copolymer has a problem in terms of the solubility in water or in a solvent. To increase the solubility in water, addition of ammonia or amines is required, and practically, smell of these additives is not preferable.

### SUMMARY OF THE INVENTION

It is an object of the invention to provide a curable resin composition comprising a new crosslinking system by which both hydrophilicity and water resistance are realized.

The present inventors made various investigations to obtain a film having both hydrophilicity and water resistance, and discovered that an N-vinyl amide polymer such as N-vinyl pyrrolidone can be crosslinked by a crosslinking agent reacting with an active hydrogen, namely the polymer can be crosslinked by a compound having two or more functional groups reacting with an active hydrogen. The present inventors also found that a cured film thus obtained had both excellent hydrophilicity and water resistance.

Hitherto, because N-vinyl amide unit such as N-vinyl pyrrolidone unit in a polymer does not have an active hydrogen, it has been considered that the polymer cannot be crosslinked by a crosslinking agent reacting with an active hydrogen. However, it was discovered that, by applying enough heat, the N-vinyl amide polymer can be crosslinked by the crosslinking agent reacting with an active hydrogen. This is a novel reaction found by the fact that N-vinyl amide polymer having no reactive functional group is cured and rendered to be insoluble by heating with the crosslinking agent reacting with an active hydrogen. An α-hydrogen of N-vinyl amide unit may possibly contribute to the reaction.

Moreover, it is known that a vinyl amide polymer such as polyvinyl pyrrolidone is self-crosslinked by means of an organic peroxides or the like, however, a film obtainable by such self-crosslinked polymer has low hydrophilicity, for example has large contact angle against water, resulting in no anti-clouding property. On the other hand, a film obtainable by a vinyl amide polymer crosslinked by the crosslinking agent according to the present invention maintains good hydrophilicity after crosslinking and has both hydrophilicity and water resistance.

The vinyl amide polymer according to the present invention may be a copolymer and it can be copolymerized with a monomer having a reactive functional group(s) in order to complement the reaction between the vinyl amide unit and the crosslinking agent. In such case, when a monomer having a carboxylic group as the reactive functional group is copolymerized, the resulting copolymer appears as insoluble in water because of a hydrogen bond between the vinyl amide group and the carboxyl group. Moreover, in order to obtain water-solubility, it is required to use an unfavorable additives such as amines, therefore, the monomer having the carboxylic group needs to be excluded as a unit to be copolymerized.

Therefore, the present invention provides a curing resin composition comprising a polymer having an N-vinyl amide unit and a crosslinking agent having functional groups reacting with an active hydrogen. The invention also provides a product which is treated by said curable resin composition.

### DETAILED DESCRIPTION OF THE INVENTION

The curable resin composition of the invention comprises a polymer having an N-vinyl amide unit and a crosslinking agent having functional groups reacting with an active hydrogen as essential components. In such curable resin composition, a cured film is formed when the curable components containing the above essential components are crosslinked. Crosslinking of curable components means crosslinking of mutual polymers in the curable components by the crosslinking agent, that is, formation of a so-called network structure by forming some chemical bond between the polymers and the crosslinking agent. The curable component is a component composed of a polymer capable of reacting with a crosslinking agent in the curable resin composition and the crosslinking agent. In the invention, the curable component comprises a polymer having an N-vinyl amide unit, and a crosslinking agent having functional groups reacting with an active hydrogen.

In the invention, the N-amide unit in the polymer having the N-vinyl amide unit is crosslinked by a crosslinking agent, and therefore it is not necessary to introduce the functional group capable of reacting with the crosslinking agent into the polymer having the N-vinyl amide unit, but if a functional group such as a hydroxyl group capable of reacting with the crosslinking agent is introduced in the polymer having the N-vinyl amide unit, the effect of the invention is not inhibited. That is, the polymer having the N-vinyl amide unit used in the invention is not required to have a functional group such as a hydroxyl group capable of reacting with the crosslinking agent, but having such functional group does not cause any problem.

In the curable resin composition of the invention, the organic components other than the above essential components are preferred to be 0 to 65 parts by weight based on 100 parts by weight of the above polymer having the N-vinyl amide unit. That is, the curable resin composition is preferred to contain 0 to 65 parts by weight of organic components other than the polymer having the N-vinyl amide unit and the crosslinking agent having functional groups reacting with an active hydrogen, which are essential components, based on 100 parts by weight of the polymer having the N-vinyl amide unit.

In said curable resin composition, if organic components other than the above essential components are contained by more than 65 parts by weight based on 100 parts by weight of the above polymer having the N-vinyl amide unit, physical properties of the cured film formed from the curable resin composition are deteriorated to thereby decline the hydrophilicity, and the action and effect by curing the curable resin composition by a novel crosslinking system may not be sufficiently obtained. More preferably, the content is not more than 50 parts by weight based on 100 parts by weight of the above polymer having the N-vinyl amide unit, still more preferably not more than 40 parts by weight, most preferably not more than 30 parts by weight.

In the above curable resin composition, the weight ratio of the polymer having the N-vinyl amide unit and the crosslinking agent having functional groups reacting with an active hydrogen may be selected properly in consideration of the species of a functional group, molecular weight of the crosslinking agent, and a functional group equivalent. Generally, when the content of the crosslinking agent exceeds 50% of the curable resin composition, the hydrophilicity is sacrificed and it is not preferred.

The above polymer having the N-vinyl amide unit is a polymer formed by polymerizing a monomer component containing an N-vinyl amide monomer, and it has high moisture absorption property and hydrophilicity. Such polymer may be used alone, or in combination of two or more species. An example of the N-vinyl amide monomer forming the above polymer having the N-vinyl amide unit is a compound represented by the following general formula (1):

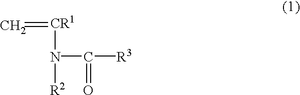

in the formula, R¹ is a hydrogen or a methyl group, R² and R³ are the same or different and each represents a hydrogen, a methyl group or an ethyl group, and R² and R³ may be bonded to form an alkylene group having 3 to 5 carbon atoms.

As the above N-vinyl amide monomer, N-vinyl acetamide, N-methyl-N-vinyl acetamide, N-vinyl formamide, N-methyl-N-vinyl formamide, N-vinyl propionamide, N-vinyl pyrrolidone and the like may be suitably used, and one or two or more species may be used as required.

In the monomer component forming the above polymer having the N-vinyl amide unit, the N-vinyl amide monomer is preferred to be contained as a main component, and at this time other monomer may be either contained or not contained, but it is preferred to contain an unsaturated monomer having a functional group capable of reacting with the crosslinking agent mentioned below. The content of N-vinyl amide monomer is preferred to be not less than 50% by weight based on 100% by weight of the total amount of monomer components. If it is less than 50% by weight, the action and effect of the invention may not be exhibited sufficiently. Preferably it is not less than 70% by weight, more preferably not less than 90% by weight. One or two or more species of the N-vinyl amide monomer may be used. When monomer components containing two or more species of monomer are polymerized, the form of polymerization may be any of block form, intersecting form, and random form, but a graft polymer is preferred in a viewpoint of the balance between the hydrophilicity and water resistance.

A preferred mode of the polymer having the N-vinyl amide unit of the invention is one having a functional group capable of reacting with the crosslinking agent. As a result, curing at low temperature is enabled, and physical properties of the cured film can be improved. As a functional group, a group other than a carboxyl group is preferred, and a hydroxyl group, an amino group, an oxazoline group and a glycidyl group are suitable. These functional groups in the polymer may be of one or two or more species. Preferably, a hydroxyl group is contained. The polymer having the N-vinyl amide unit and such functional group can be obtained by copolymerization of the above-mentioned N-vinyl amide monomer and a monomer component containing an unsaturated monomer having the functional group(s).

Other monomers than the N-vinyl amide monomer that can be contained in the above monomer component include polymerizable monomers which can be copolymerized with the N-vinyl amide monomer, and suitable are (1) (meth)acrylic esters such as methyl (meth)acrylate, ethyl (meth)acrylate, butyl (meth)acrylate, cyclohexyl (meth)acrylate, hydroxyethyl (meth)acrylate, etc.; (2) (meth)acrylic amide derivatives such as (meth)acrylic amide, N-monomethyl (meth)acrylic amide, N-monoethyl (meth)acrylic amide, N,N-dimethyl (meth)acrylic amide, etc.; (3) dimethyl aminoethyl (meth)acrylate, dimethyl aminoethyl (meth)acrylic amide, vinyl pyridine, vinyl imidazole, and other basic unsaturated monomers, their salts and quaternarized products; (4) imino ethers such as vinyl oxazoline, isopropenyl oxazoline, etc.; (5) unsaturated monomers having a hydroxyl group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, methyl 2-(hydroxymethyl) acrylate, ethyl 2-(hydroxymethyl) acrylate, polyethylene glycol mono(meth)acrylate, polypropylene glycol mono(meth)acrylate, di(meth)acrylate of tris(hydroxyethyl) isocyanurate, pentaerythritol tri(meth)acrylate, etc.; (6) unsaturated anhydrides such as maleic anhydride, itaconic anhydride, etc.; (7) vinyl esters such as vinyl acetate, vinylpropionate, etc.; (8) vinyl ethylene carbonate and its derivatives; (9) styrene and its derivatives; (10) (meth) acrylic acid-2-ethyl sulfonate and its derivative; (11) vinyl sulfonate and its derivatives; (12) vinyl ethers such as methyl vinyl ether, ethyl vinyl ether, butyl vinyl ether, etc.; (13) olefins such as ethylene, propylene, octene, butadiene, etc.; and (14) unsaturated monomers having a glycidyl group such as glycidyl (meth)acrylate, etc. These may be used alone or in combination of two or more species. Among them, since the preferred modes of the polymer are ones having a hydroxyl group, an amino group, an oxazoline group, and/or a glycidyl group, it is preferred to use monomers having these groups, that is, monomers of (3), (4), (5), and/or (14). As the unsaturated monomer having a hydroxyl group, it is most preferable to use 2-hydroxyethyl (meth)acrylate.

In the invention, the above polymer having the N-vinyl amide unit is preferred to be an N-vinyl pyrrolidone polymer. As a result, the action and effect of the invention can be exhibited sufficiently. The N-vinyl pyrrolidone polymer is a polymer obtainable by using the N-vinyl pyrrolidone as N-vinyl amide monomer in the monomer component forming the polymer having the N-vinyl amide unit.

As a production method of the above polymer having the N-vinyl amide unit, aqueous solution polymerization method, solution polymerization in an organic solvent, reverse phase suspension polymerization method, emulsification polymerization method, and sedimentation polymerization are suitable, and the reaction conditions in polymerization are not particularly limited. As the polymerization initiator to be used, one or two or more species of known polymerization inhibitor may be used, and the amount of use is not particularly limited. Without using polymerization initiator, heat, light or radiation may be used in polymerization.

The molecular weight of the above polymer having the N-vinyl amide unit is preferred to be not lower than 1,000 in the weight-average molecular weight, and preferably not higher than 5,000,000. If it is less than 1,000, the water resistance and mechanical strength of the cured film may not be sufficient, and if it exceeds 5,000,000, the working efficiency is not enough when forming the cured film. More preferably, it is not lower than 5,000, still more preferably not lower than 10,000. More preferably, it is not higher than 3,000,000, and still more preferably not higher than 1,500,000.

The crosslinking agent having functional groups reacting with an active hydrogen in the invention may be a compound or a polymer having two or more functional groups reacting with an active hydrogen in one molecule. That is, a compound having two or more functional groups reacting with an active hydrogen in one molecule, or a polymer having two or more functional groups reacting with an active hydrogen in one molecule on average can be used. One or two or more species of such crosslinking agents may be used. The functional groups reacting with an active hydrogen contained in one molecule of the crosslinking agent may be one or two or more species.

In the above crosslinking agent, the above functional group reacting with an active hydrogen is preferred to be at least one species selected from the group consisting of an isocyanate group, an epoxy group, an oxazoline group, an aziridinyl group, a carbodiimide group, an alkoxy silane group, a cyclocarbonate group, a methylol group, a methylol alkyl group, a vinyl ether group and an amino group. By containing the crosslinking agent having such functional groups, physical properties of the cured film formed from the curable resin composition are improved, and an excellent hydrophilicity and other properties are expressed. Among them, the crosslinking agent having an isocyanate group or the crosslinking agent having a methylol group and/or a methylol alkyl group is preferably used.

As the above crosslinking agent having an isocyanate group, suitable examples of an organic diisocyanate compound include cyclic diisocyanates such as xylilene diisocyanate, isoforon diisocyanate, alicyclic diisocyanate, and the like; aromatic diisocyanates such as trilene diisocyanate, 4,4-diphenyl methane diisocyanate, and the like; and aliphatic diisocyanates such as hexamethylene diisocyanate, and the like. Suitable examples of a polyisocyanate resin include adducts of these organic diisocyanate compounds with polyhydric alcohol, low molecular weight polyester resin (polyester polyol) or water; polymers of organic diisocyanate compounds containing isocyanurate type polyisocyanate compounds, and isocyanate biuret. Further, as block isocyanate resins, resins obtainable by blocking the above polyisocyanate resin by known blocking agent are suitable.

Commercial products of the above crosslinking agent having an isocyanate group include polyisocyanate resins such as “Burnock DN-980” and “Burnock DN-990” (both being trade names and products of Dainippon Ink and Chemicals, Inc.), and block isocyanate resins such as “Burnock DB-98OK” (trade name, product of Dainippon Ink and Chemicals, Inc.), “Coronate 2507” (trade name, product of Nippon Polyurethane Co.), “Takenate B-815N” (trade name, product of Takeda Chemical Industries, Ltd.), “Duranate” (trade name, product of Asahi Kasei Co.), and “Elastron” (trade name, product of Daiichi Kogyo Seiyaku Co., Ltd.).

The above crosslinking agent having an epoxy group(s) suitably includes compounds having two epoxy groups such as polyethylene glycol diglycidyl ether, bisphenol A type diglycidyl ether, polypropylene glycol diglycidyl ether, neopentyl glycol diglycidyl ether, glycerin diglycidyl ether, and the like; and compounds having three or more epoxy groups such as glycidyl ether of polyethylene glycol having three or more functional groups, trimethylol propane polyglycidyl ether, sorbitol polyglycidyl ether, sorbitan polyglycidyl ether, polyglycerol polyglycidyl ether, and the like. Commercial products include, for example, “Epolite” (trade name, product of Kyoei Chemical Co.) and “Denacol” (trade name, product of Nagase Kasei Kogyo Co.).

The above crosslinking agent having an oxazoline group suitably includes 2,2′-bis-(2-oxazoline), 2,2′-methylene-bis-(2-oxazoline), 2,2′-ethylene-bis-(2-oxazoline), 2,2′-trimethylene-bis-(2-oxazoline), 2,2′-tetramethylene-bis-(2-oxazoline), 2,2′-hexamethylene-bis-(2-oxazoline), 2,2′-octamethylene-bis-(2-oxazoline), 2,2′-ethylene-bis-(4,4′-dimethyl-2-oxazoline), 2,2′-p-phenylene-bis-(2-oxazoline), 2,2′-m-phenylene-bis-(2-oxazoline), 2,2′-m-phenylene-bis-(4,4′-dimethyl-2-oxazoline), bis-(2-oxazolinyl cyclohexane) sulfide, bis-(2-oxazolinyl norbornane) sulfide, and other functional oxazoline compounds, Epoclos (trade name, product of Nippon Shokubai Co., Ltd), and other polymer having an oxazoline group.

The above crosslinking agent having an aziridinyl group suitably includes “Chemitight DZ-22E” and “Chemitight FZ-33” (both being trade names and products of Nippon Shokubai Co., Ltd.) and other crosslinking agent having an aziridinyl group.

The above crosslinking agent having a methylol group and/or a methylol alkyl group suitably includes compounds containing an N-methylol group and/or an N-methylol alkyl group, and melamine resin, urea resin and other so-called amino resins are suitable.

As the above crosslinking agent having a methylol group and/or a methylol alkyl group, melamine resin, urea resin, and benzoguanamine resin are suitable. Among these, melamine resin and urea resin are preferred.

As the above melamine resin, there may be mentioned such species as complete alkyl group type melamine resin, methylol group type melamine resin, imino group type melamine resin, and methylol-imino group type melamine resin, and among them, methylated melamine resin, butylated melamine resin, and mixed alkylated melamine resin are suitable.

As required, a catalyst may be added corresponding to each crosslinking agent. For example, when a crosslinking agent having an isocyanate group is used as the crosslinking agent, the reaction is promoted by using a catalyst used in urethane forming reaction, and an amine catalyst (triethylamine, N-ethyl morpholine, triethylene diamine, etc.), a tin catalyst (dibutyltindilaurylate, dioctyltindilaurylate, tinoctylate, etc.), and titanium catalyst (tetrabutyl titanate, etc.) can be used. When a crosslinking agent having an epoxy group is used, an amine catalyst and an acidic catalyst are suitable, when a crosslinking agent having an oxazoline group is used, an acidic catalysts is suitable, and when a crosslinking agent having a methylol group is used, an acidic catalyst such as carboxylic acid type, phosphoric acid type, ester phosphate type, sulfonic acid type, ester sulfonate type, persulfate type, onium salt type, and the like are suitable.

In the curable resin composition of the invention, as required, an additive(s), such as stabilizers, pigments, inorganic fillers, film forming aids, lubricants, and antibacterial agents may be added.

As the mode of use of the curable resin composition of the invention, it is preferred to be used as a treating agent having the compound dissolved or dispersed in water or an aqueous solvent. An aqueous solvent is one solvent or mixed solvent of two or more species that can be mixed in water, or a mixed solvent having water mixed as a main component in such solvent. A surfactant may be also mixed in water or an aqueous solvent.

Since the curable resin composition of the invention provides a product surface with hydrophilicity and other characteristics, it is suitably applied in surface treatment of the product. When a product is treated by the curable resin composition of the invention, it comes to have a cured film formed by the curable resin composition of the invention on its surface. Therefore, the cured film which has satisfactory physical properties and hence, can express excellent hydrophilicity and other characteristics are formed on the surface. Therefore, the product can be used in various applications. Such product is also included in the scope of the invention. Shapes of such product suitably include thin plates, films, fibers, hollow fibers, and nonwoven cloth. The preferred material of the product includes metals such as aluminum and aluminum alloy; glass; plastics such as PET resin, urethane resin, epoxy resin, polyvinyl chloride resin, acrylic resin, ABS resin, AS resin, polystyrene resin, and polycarbonate resin; and cellulose such as paper. The surface of the product may also be pretreated for improving the adhesiveness with the curable resin composition. Treatment technologies applicable to the surface of such product suitably include treatment by phosphoric acid chromate, chromic acid chromate, or zircon; treatment by organic matter; corona discharge treatment; low temperature plasma treatment; and short wavelength ultraviolet irradiation treatment and the like.

The curable resin composition of the invention can form a cured film on the surface of products made of various materials as mentioned above, and the surface material of the product is preferably an organic base material from the viewpoint of adhesiveness with the cured film or a cellulose base material such as paper among the examples above. Among organic base materials, it is preferred to be applied on PET resin, urethane resin, epoxy resin or polyvinyl chloride resin. PET resin is more preferred, and it is suitable to be applied on a PET film.

The method of forming a cured film on the above product surface using the curable resin composition is not particularly limited, and includes coating, dipping, and spraying. More specifically, it is preferred to be carried out by applying the curable resin composition uniformly on the product surface in a form of a treating agent, or by dipping the product in said treating agent followed by drying and curing. When applying the treating agent, roll coater or the like coating machine can be used, for instance.

The curing temperature of the curable resin composition of the invention may be appropriately selected depending on the species of the crosslinking agent. For example, when using the crosslinking agent having an isocyanate group, it is preferred to select not lower than 100° C., and preferably not higher than 200° C. When using the crosslinking agent having an epoxy group or the crosslinking agent having an oxazoline group, not lower than 150° C. is preferred, and not higher than 200° C. is preferred. When using the crosslinking agent having a methylol group, not lower than 170° C. is preferred, and not higher than 240° C. is preferred. When using a catalyst, crosslinking at lower temperature is possible in each case.

As applications of the product which is treated by the curable resin composition of the invention, these products are suitably used in the application in which surface hydrophilicity is required, for example, in heat exchanger of air conditioner and others, since the product can be provided with functions of preventing bonding of condensate water or of having an antistatic property by means of hydrophilicity. In such case, for example, the product is processed by blanking or bending to be formed as fins, and attached to copper pipes and others.

The curable resin composition of the invention is also suitably applied in inkjet receptor layer or its binder. Thus, when the curable resin composition of the invention is used as the material for ink jet receptor layer or receptor layer binder, it is a preferred embodiment of the invention, and a PET film or a nonwoven cloth is suitably used as the base material.

In this case, since the cured film formed from the curable resin composition of the invention has both water absorbing and water resistance properties, an excellent dryness and water resistance of printing will be obtained.

The curable resin composition of the invention is effective for hydrophilic treatment of the PET film surface as mentioned above, such product is suitable for food packaging, however. Moreover, since various products may be provided with anti-clouding and antistatic properties, it is suitably applied in products required to have such properties, and it can also suitably be applied in primer application. Further, the cured film formed from the curable resin composition of the invention is biocompatible, and the polymer having the N-vinyl amide unit is hardly eluted, and hence it can be suitably used in biocompatible materials such as antithrombotic materials. Such materials include, for example, hollow fiber membranes used in medical field such as artificial kidney, or in removal, separation, and recovery of specific substances. Hitherto, such products were treated by melting and kneading polysulfone with PVP, or spinning from a common solvent, but by treating with the curable resin composition of the invention, further followed by curing, elution of PVP component can be suppressed while maintaining an excellent biocompatibility.

The curable resin composition of the invention is composed as referred hereinabove, and can be crosslinked by a new crosslinking system, and therefore the cured film formed from the same is excellent in physical properties and can express a superior hydrophilicity and like characteristics.

### EXAMPLES

The invention is further described by presenting Examples, but it must be noted that the invention is not limited by these Examples alone.

### Examples 1 to 6 and Comparative Example 1

In the composition shown in Table 1, using N-vinyl amide polymer and a crosslinking agent, a varnish with 10% by weight nonvolatile content containing the curable resin composition was prepared. This varnish was applied on a glass plate in a thickness of 30 μm by means of an applicator, and it was heat-treated by a hot air dryer for 10 minutes at 170° C. to prepare a glass plate having a cured film. The obtained glass plate having the cured film was subjected to the following water resistance test and hydrophilicity test. Results are shown in Table 1.

Water resistance test

(1) Rubbing test

Using the glass plate having the cured film, rubbing test was conducted (30 times).

Evaluation criteria

∘: No flaw

Δ: Flawed

X: Eluted

XX: No gel noted

(2) Immersion

The glass plate having the cured film was immersed in ion-exchange water for 10 minutes at room temperature, and the state of the cured film was visually observed.

Hydrophilic test

Using the glass plate having the cured film, anti-clouding property was evaluated by expiration test.

Evaluation criteria

∘: Not clouding

Δ: Partly clouding

X: Clouding

TABLE 1

| | Example | | | | | | Compar. Ex. |
|---|---|---|---|---|---|---|---|
| | 1 | 2 | 3 | 4 | 5 | 6 | 1 |
| Composition of | | | | | | | |
| curable resin | | | | | | | |
| composition | | | | | | | |
| (parts by weight) | | | | | | | |
| PVP | 90 | 70 | 70 | 60 | 50 | 50 | 60 |
| PVA | — | — | — | — | 30 | 35 | 40 |
| Crosslinking | 10 | 30 | — | 40 | 20 | 15 | — |
| agent (1) | | | | | | | |
| Crosslinking | — | — | 30 | — | — | — | — |
| agent (2) | | | | | | | |
| Evaluation result | | | | | | | |
| Rubbing | Δ | ◯ | ◯ | ◯ | ◯ | Δ | x |
| Immersion | Flawed | No change | No change | No change | No change | Flawed | Eluted |
| Anti-clouding | ◯ | ◯ | ◯ | ◯ | ◯ | Δ | Δ |

Referring to Table 1, the content is described in the following.

PVP is polyvinyl pyrrolidone (trade name “K-90”, product of Wako Pure Chemical Co.), PVA is polyvinyl alcohol (trade name “PVA-220”, product of Kuraray Co.), crosslinking agent (1) is a thermal reactive water-soluble urethane resin “Elastron H-3” (trade name, product of Daiichi Kogyo Seiyaku Co., Ltd.), and crosslinking agent (2) is polyisocyanate “Duranate E402-90T” (trade name, product of Asahi Kasei Co., Ltd.).

In Table 1, it was considered from the result of Example 6 that the curing reaction between PVP and the crosslinking agent was inhibited to lower the water resistance because not less than 65% by weight of PVA on a polymer having an N-vinyl amide unit as an organic component other than the essential components was added. Hence, the preferred content of the organic component other than the essential components was found to be not more than 65% by weight on a polymer having an N-vinyl amide unit. It was found from the result of Comparative Example 1 that crosslinking of the curable resin composition did not take place unless a crosslinking agent having functional groups reacting with an active hydrogen was contained.

### Examples 7 to 11 and Comparative Example 2

In the composition shown in Table 2, using N-vinyl amide polymer and a crosslinking agent, a varnish with 10% by weight of nonvolatile content containing the curable resin composition was prepared. This varnish was applied on a glass plate in a thickness of 30 μm by means of an applicator, and it was heat-treated by a hot air dryer for 20 minutes at 200° C. to prepare a glass plate having a cured film. The obtained glass plate having the cured film was subjected to the above-mentioned water resistance test and hydrophilicity test. Results are shown in Table 2.

TABLE 2

| | | | | | | Compar. |
|---|---|---|---|---|---|---|
| | Example | | | | | Ex. |
| | 7 | 8 | 9 | 10 | 11 | 2 |
| Composition of curable | | | | | | |
| resin composition | | | | | | |
| (parts by weight) | | | | | | |
| PVP | 90 | 70 | 70 | 50 | 50 | 60 |
| PAA | — | — | — | 30 | 35 | 40 |
| (another organic | | | | | | |
| component) | | | | | | |
| Water-soluble | 10 | 30 | — | 20 | 15 | — |
| melamine resin | | | | | | |
| Urea resin | — | — | 30 | — | — | — |
| Evaluation result | | | | | | |
| Rubbing | Δ | ◯ | ◯ | ◯ | Δ | x |
| Immersion | Flawed | No change | No change | No change | Flawed | Eluted |
| Anti-clouding | ◯ | ◯ | ◯ | ◯ | ◯ | Δ |

Referring to Table 2, the content is described in the following.

PVP is polyvinyl pyrrolidone (tradfe name “K-90”, product of Wako Pure Chemical Co.), PAA is polyacrylic acid (trade name “Julimer AC10L”, product of Nippon Junyaku Co.), water-soluble melamine resin is “NikaluckMX-035” (trade name, product of Sanwa Chemical Co.), and urea resin is “UFR65” (trade name, product of Mitsui Sitec Co.).

In Table 2, it was considered from the result of Example 11 that the curing reaction of the PVP and the crosslinking agent was inhibited to lower the water resistance because not less than 65% by weight of PAA as an organic component other than the essential components was added. Hence, more preferred content of the organic component other than the essential components was found to be not more than 65% by weight. It was found from the result of Comparative Example 2 that crosslinking of the curable resin composition did not take place unless a crosslinking agent having a methylol group and/or a methylol alkyl group was contained.

### Examples 12 and 13

By blending 10 parts by weight of polyvinyl pyrrolidone (PX-K90L, product of Nippon Shokubai Co., Ltd.) as N-vinyl amide polymer and 1.9 parts by weight of water-soluble melamine (trade name “Nikaluck MX035”, product of Sanwa Chemical Co.) and diluting in water, a varnish with 0.1% by weight of nonvolatile content containing the curable resin composition was prepared. This varnish was applied on a PET film of 100 μm in thickness (trade name “Lumirror” Type: T, product of Toray Industries, Inc.) so as to obtain a dry film thickness of 0.03 μm. By carrying out a specified heat treatment according to Table 3, test pieces were prepared.

### Comparative Example 3

A PET film of 100 μm in thickness (trade name “Lumirror” Type: T, product of Toray Industries, Inc.) was prepared as a test piece.

Using these test pieces prepared as above, the cellophane tape (R) peeling, moisture absorption, and contact angle were evaluated. Results are shown in Table 3.

(Cellophane tape (R) peeling)

The test was conducted according to the conventional method. The test was carried out initially, after 24 hours of immersion in water, 1 hour in boiling water, and after drying at 60° C.

(Moisture absorption)

After standing the test piece for 24 hours in the condition of 30° C. and 90% RH, the weight change was measured, and moisture absorption was calculated according to the following formula. Moisture absorption (%)=weight after absorbing moisture/dry weight

(Contact angle)

After standing the test piece for 24 hours in the condition of 20° C. and 90% RH, the contact angle to water was measured. The test was carried out initially, after 24 hours of immersion in water, 1 hour in boiling water, and after drying at 60° C.

TABLE 3

| | | Example | | Compar. Ex. |
|---|---|---|---|---|
| | | 12 | 13 | 3 |
| Film | | PVP/MX035 = | PVP/MX035 = | — |
| | | 6/4 (wt.) | 6/4 (wt.) | (PET film |
| | | | | (neat)) |
| Heat treatment | | 200° C. | 230° C. | — |
| | | 30 sec. | 10 sec. | (Untreated) |
| Cellophane tape | Initial | None | None | — |
| peeling | Immersed in | None | None | — |
| | water | | | |
| | for 24 hrs | | | |
| | Immersed in | None | None | — |
| | boiling water | | | |
| | for 1 hr | | | |
| 30° C. | Moisture | 0.40 | 0.24 | 0.31 |
| 90% RH*24 hr | absorption (%) | | | |
| | Warp | None | None | None |
| | Tack | None | None | None |
| Contact angle (°) | Initial | 27.0 | 26.3 | 71.3 |
| 20° C. 60% RH | Immersed in | 24.4 | 29.8 | — |
| | water | 24.4 | 29.8 | |
| | for 24 hrs | | | |
| | Immersed in | 26.0 | 32.6 | — |
| | boiling water | | | |
| | for 1 hr | | | |

Referring to Table 3, the content is described in the following. Regarding the film, PVP/MX035=6/4 (wt.) means that the film was formed by using a curable resin composition comprising N-vinyl amide polymer (PX-K90L, product of Nippon Shokubai Co., Ltd.)/water-soluble melamine (trade name “Nikaluck MX035”, product of Sanwa Chemical Co.)=6/4 (ratio by weight).

In Table 3, the PVP coating showed an excellent adhesiveness to the PET film. Further, the film surface was made hydrophilic by PVP coating, and the contact angle to water was significantly lowered. Further, by crosslinking treatment, it was found that the water immersion, boiling water immersion and hydrophilic effect lasted longer. Therefore, the PVP crosslinking coating was found to render hydrophilic the surface of PET film at high level, and this effect persisted after boiling water test.

### Examples 14 to 16

In the composition shown in Table 4, N-vinyl amide polymer (PX-K90L, product of Nippon Shokubai Co., Ltd.) and a water-soluble melamine (trade name “Nikaluck MX035”, product of Sanwa Chemical Co.) were mixed, and a varnish with 20% by weight nonvolatile content containing the curing resin composition was prepared. This varnish was applied on a PET film of 100 μm in thickness (trade name “Lumirror” Type: T, product of Toray Industries, Inc.) so as to obtain a dry film thickness of 18 μm. By carrying out a specified heat treatment according to Table 4, an ink jet receptor layer was prepared and formed as a test piece.

### Comparative Example 4

A PET film of 100 μm in thickness (trade name “Lumirror” Type: T, product of Toray Industries, Inc.) was prepared as a test piece.

### Comparative Example 5

An OHP sheet for ink jet (trade name “CF102”, product of Canon Inc.) was prepared as a test piece.

Using these test pieces prepared as above, or commercial films, moisture absorption, dryness, water resistance of a film, and water resistance of a printed image were evaluated. Results are shown in Table 4.

(Water absorption)

By the weight change after immersing a test piece in ion-exchange water for 24 hours, the water absorption was calculated according to the following formula. Water absorption (%)=100×[(weight after immersion)−(dry weight)]/[(dry weight)−(dry PET film weight)]

(Dryness)

Color transfer in 30 seconds after printing was qualitatively judged by touching.

∘: No color transfer

Δ: Slight color transfer

X: Color transferred

(Water resistance of a film)

Using test pieces, the rubbing test of a clear film (ink jet receptor layer itself) was conducted (50 times).

Evaluation criteria

⊚: No change

∘: Flawed

Δ: Flaw or peel within 30 times

X: Eluted (gel obviously noted)

XX: Eluted (no gel noted)

(Water resistance of a printed image)

Water drops were applied on the image printed on the receptor layer, and changes were observed.

Evaluation criteria

⊚: No change; faded by rubbing

Δ: No change to slight blurring, erased by rubbing

X: Blurring

XX: Image lifted and dissolved immediately

TABLE 4

| | Example | | | Compar. Ex. | |
|---|---|---|---|---|---|
| | 14 | 15 | 16 | 4 | 5 |
| Film | Lumirror | Lumirror | Lumirror | Lumirror | CF102 |
| Composition of | 60/40 | 60/40 | 80/20 | No receptor | — |
| receptor layer | | Catalyst | Catalyst | layer | |
| PVP/melamine | | 1 phr* | 1 phr* | | |
| (by weight) | | | | | |
| Heat treatment | 200° C. * | 170° C. * | 170° C. * | — | — |
| | 20 min. | 20 min. | 20 min. | | |
| Appearance | Colorless and | Colorless and | Colorless and | Colorless and | Turbid and |
| | transparent | transparent | transparent | transparent | rough |
| Printing | Applicable | Applicable | Applicable | Not | Applicable |
| | | | | applicable | |
| Water | 147 | 157 | 259 | — | Dissolved |
| absorption (%) | | | | | |
| Dryness | Δ-x | Δ-x | ◯ | — | Δ |
| Water resistance | ◯ | ⊚ | ◯ | — | xx |
| of film | | | | | |
| Water resistance | Δ | Δ | ◯ | — | xx |
| of printed image | | | | | |

* Catalyst: Sodium persulfate

Referring to Table 4, the content is described in the following. In the film, Lumirror is a PET film of 100 μm in thickness (trade name “Lumirror” Type: T, product of Toray Industries, Inc.), and CF102 is an OHP sheet for inkjet (trade name “CF102”, product of Canon Inc.). In the composition of the receptor layer, PVP/melamine (by weight) is the weight ratio of N-vinyl amide polymer (PX-K90L, product of Nippon Shokubai Co., Ltd.) and a water-soluble melamine (trade name “Nikaluck MX035”, product of Sanwa Chemical Co.), and catalyst lphr means 1 part by weight of sodium persulfate was added based on 100 parts by weight of the total weight of PVP and melamine.

As it was obvious from Table 4, by using PVP crosslinking coating, excellent appearance and water resistance of printing were obtained as compared with the case of using commercial OHP film for inkjet. Since the PVP crosslinking film has both water absorption and water resistance properties, an ink jet receptor layer excellent in both dryness and water resistance properties was obtained.

Synthesis Example 1 (NVP/HEA (1): Synthesis of a random copolymer of NVP and HEA)

A reaction vessel was charged with 80 parts by weight of ion exchange water and 16 parts by weight of NVP (N-vinyl pyrrolidone) and heated to 70° C. in nitrogen atmosphere. Immediately after feeding 0.2 part by weight of 10% IPA solution of 2,2′-azobis 2-methyl butylonitrile, 4 parts by weight of HEA (2-hydroxyethyl acrylate) was added dropwise over 90 minutes. At the end of dripping, the internal temperature reached 95° C., and the reaction was continued for 2 hours while keeping at 95° C. The mixture was allowed to be cooled to room temperature to give a colorless clear polymer solution.

Synthesis Example 2 (NVP/HEA (2): Synthesis of a graft copolymer of NVP and HEA)

In 68 parts by weight of ion exchange water, 12 parts by weight of PVP (trade name “K-30”, product of Wako Pure Chemical Co.) was dissolved, and heated to 95° C. in nitrogen atmosphere. By adding 6 parts by weight of HEA and 14 parts by weight of 1.3% aqueous solution of ammonium persulfate dropwise over 90 minutes to proceed polymerization, the reaction was further continued after the end of dripping for 2 hours while keeping at 95° C. The mixture was allowed to be cooled to room temperature to give a yellow clear polymer solution.

Synthesis Example 3 (NVP/NH2: Synthesis of a copolymer of NVP and allylamine)

A pressure resistance and sealable vessel was charged with 10 parts by weight of N-vinyl pyrrolidone, 1 part by weight of allylamine, 39 parts by weight of isopropyl alcohol and 0.5 part by weight of di-t-butyl peroxide and the reaction was allowed to proceed at 130° C. for 10 hours with stirring. The obtained polymerized solution was re-precipitated and purified with ethanol/hexane to give a water-soluble copolymer NVP/NH2.

### Examples 17 to 21

In the composition shown in Table 5, each vinyl pyrrolidone copolymer (VP copolymer) synthesized in Synthesis Examples 1 to 3, was blended with the crosslinking agent and the catalyst, and a varnish with 20% by weight nonvolatile content containing the curable resin composition was prepared. This varnish was applied on a PET film of 100 μm in thickness (tradename “Lumirror” Type: T, product of Toray Industries, Inc.) so as to obtain a dry film thickness of 18 μm. By carrying out a specified heat treatment according to Table 5, an ink jet receptor layer was prepared and formed as a test piece. Using the test pieces prepared as above, the water resistance test (rubbing test), hydrophilicity test, dryness, and water resistance of the film were evaluated in a similar manner as mentioned above.

Water resistance test

Rubbing test

Using test pieces, rubbing test of a clear film (ink jet receptor layer itself) was conducted (50 times) same as in Examples 14 to 16.

Hydrophilicity test

Using the glass plate having the cured film, anti-clouding property was evaluated by expiration test same as in Examples 1 to 6.

Ink jet evaluation

Dryness and water resistance (water resistance of the printed image) of ink jet receptor layer were evaluated same as in Examples 14 to 16.

TABLE 5

| | | Example | | | | |
|---|---|---|---|---|---|---|
| | | 17 | 18 | 19 | 20 | 21 |
| Composition of curable resin | | | | | | |
| composition (parts by weight) | | | | | | |
| VP | NVP/HEA (1) | 8 | — | — | — | — |
| copolymer | NVP/HEA (2) | — | 8 | 8 | 8 | — |
| | NVP/NH2 | — | — | — | — | 8 |
| Crosslinking | Melamine resin | 2 | 2 | — | — | — |
| agent | Isocyanate | — | — | 2 | — | — |
| | crosslinking agent | | | | | |
| | Epoxy | — | — | — | — | 2 |
| | crosslinking agent | | | | | |
| | Aziridine | — | — | — | 2 | — |
| | crosslinking agent | | | | | |
| Catalyst | pTS | 0.1 | 0.1 | — | — | — |
| | DBTDL | — | — | 0.01 | — | — |

| Heat treatment | 150° C. * 10 min. | | | 120° C. * 1 min. | |
|---|---|---|---|---|---|
| Evaluation | | | | | |
| Rubbing | ⊚ | ⊚ | ⊚ | ⊚ | ⊚ |
| Anti-clouding | ◯ | ◯ | ◯ | ◯ | ◯ |

| | | | | | | |
|---|---|---|---|---|---|---|
| Inkjet | Dryness | ◯ | ◯ | ◯ | ◯ | ◯ |
| evaluation | Water resistance | ◯ | ◯ | ◯ | ◯ | ◯ |

Referring to Table 5, the content is described in the following. In the VP (vinyl pyrrolidone) copolymer, NVP/HEA (1) is a random copolymer of N-vinyl pyrrolidone (NVP) and 2-hydroxyethyl acrylate (HEA), NVP/HEA (2) is a graft copolymer of NVP and HEA, NVP/NH2 is a copolymer of NVP and allylamine. In the crosslinking agent, melamine resin is Nikaluck MX035 (trade name, product of Sanwa Chemical Co.), and isocyanate crosslinking agent is Bihidure BL5140 (trade name, product of Sumitomo Bayer Urethane Co.). The epoxy crosslinking agent is “Denacol EX810” (trade name, product of Nagase Kasei Kogyo Co.) and an aziridine crosslinking agent is “Chemitight FZ-33” (trade name, product of Nippon Shokubai Co., Ltd.). In the catalyst, pTS is p-toluene sulfonic acid, and DBTDL is dibutyl tin dilaurilate.

As obvious from Table 5, since the crosslinking film formed from the NVP copolymer has both water absorption and water resistance properties, an ink jet receptor layer excellent in both dryness and water resistance is obtained.

1. A curable resin composition comprising
a polymer having an N-vinyl amide unit and a compound having two or more functional groups reacting with an active hydrogen.

2. The curable resin composition according to claim 1,
wherein a content of organic components other than said essential components is 0 to 65 parts by weight based on 100 parts by weight of said polymer.

3. The curable resin composition according to claim 1,
wherein said functional group reacting with an active hydrogen is at least one species selected from the group consisting of anisocyanate group, an epoxy group, an oxazoline group, an aziridinyl group, a carbodiimide group, an alkoxy silane group, a cyclocarbonate group, a methylol group, a methylol alkyl group, a vinyl ether group and an amino group.

4. A product which is treated by the curable resin composition according to claim 1.

5. The curable resin composition according to claim 2,
wherein said functional group reacting with an active hydrogen is at least one species selected from the group consisting of an isocyanate group, an epoxy group, an oxazoline group, an aziridinyl group, a carbodiimide group, an alkoxy silane group, a cyclocarbonate group, a methylol group, a methylol alkyl group, a vinyl ether group and an amino group.

6. A product which is treated by the curable resin composition according to claim 2.

7. A product which is treated by the curable resin composition according to claim 3.
